(19) United States
(12) Patent Application Publication
(10) Pub. No.: US 2017/0331686 A1
(43) Pub. Date: Nov. 16, 2017

(54) INTERNET OF VEHICLES, BASE STATION, AND DYNAMIC RESOURCE MANAGING METHOD THEREOF

(71) Applicant: INDUSTRIAL TECHNOLOGY RESEARCH INSTITUTE, HSINCHU (TW)

(72) Inventors: Hua-Lung Tsai, Taipei City (TW); Chorng-Ren Sheu, Kaohsiung City (TW); Chun-Yi Wei, New Taipei City (TW)

(73) Assignee: INDUSTRIAL TECHNOLOGY RESEARCH INSTITUTE, HSINCHU (TW)

(21) Appl. No.: 15/390,914

(22) Filed: Dec. 27, 2016

Related U.S. Application Data
(60) Provisional application No. 62/335,114, filed on May 12, 2016.
(60) Provisional application No. 62/372,328, filed on Aug. 9, 2016.

(30) Foreign Application Priority Data
Nov. 10, 2016 (TW) 105136646

(51) Int. Cl. H04L 12/24; H04L 29/08; H04W 72/04; H04L 5/00; H04W 88/08; H04W 84/00

(52) U.S. Cl. CPC H04L 41/0816; H04W 72/0413; H04L 41/0893; H04L 5/0048; H04L 67/12; H04W 84/005; H04W 88/08

(57) ABSTRACT

An internet of vehicles, a base station, and a dynamic resource managing method thereof are provided. The dynamic resource managing method includes the following steps: At least one base station receives a transmission request from at least one vehicle mounted device. The base station initially plans a resource configuration according to a location distribution of the vehicle mounted device. At least part of the resource configuration which is initially planned is transmitted to the vehicle mounted device from the base station. The base station updates the resource configuration. At least part of the resource configuration which is updated is transmitted o the vehicle mounted device from the base station.

This application claims the benefits of U.S. provisional application Ser. No. 62/335,114, filed May 12, 2016, U.S. provisional application Ser. No. 62/372,328, filed Aug. 9, 2016, Taiwan application Serial No. 105136646, filed Nov. 10, 2016, the disclosure of which are incorporated by reference herein in its entirety.

### TECHNICAL FIELD

The disclosure relates in general to an internet of vehicles, a base station and a dynamic resource managing method thereof.

### BACKGROUND

Along with the development of communication, an internet of vehicles is invented. In the internet of vehicles, several vehicle mounted devices, such as electric devices or electronic tags disposed on vehicles, can transmit static information or dynamic information to a base station. The operation of the vehicles can be effectively monitored and several services can be provided to those vehicles.

However, when the vehicles are congested, the resource pools of the base station assigned to the vehicles may be conflicted. The transmission efficiency is reduced, so the researchers are trying to improve the situation of resource conflicts.

### SUMMARY

The disclosure is directed to an internet of vehicles, a base station and a dynamic resource managing method thereof.

According to one embodiment, a dynamic resource managing method of an internet of vehicles is provided. The dynamic resource managing method includes the following steps: A transmission request is received from at least one vehicle mounted device by at least one base station. A resource configuration is initially planned according to a location distribution of the at least one vehicle mounted device by the base station. At least part of the resource configuration which is initially planned is transmitted to the at least one vehicle mounted device from the base station. The resource configuration is updated by the base station. At least part of the resource configuration which is updated is transmitted to the at least one vehicle mounted device from the base station.

According to another embodiment, an internet of vehicles is provided. The internet of vehicles includes at least one vehicle mounted device and at least one base station. The at least one vehicle mounted device is for transmitting a transmission request. The at least one base station is for receiving the transmission request, initially planning a resource configuration according to a location distribution of the at least one vehicle mounted, and transmitting at least part of the resource configuration which is initially planned to the at least one vehicle mounted device. The base station is further for updating the resource configuration and transmitting at least part of the resource configuration which is updated to the at least one vehicle mounted device.

According to alternative embodiment, a base station is provided. The base station includes a transmitting unit, a planning unit and a processing unit. The transmitting unit is for receiving a transmission request from at least one vehicle mounted device. The planning unit is for initially planning a resource configuration according to a location distribution of the at least one vehicle mounted. The transmitting unit is further for transmitting at least part of the resource configuration which is initially planned to the at least one vehicle mounted device. The processing unit is for controlling the planning unit to update the resource configuration and controlling the transmitting unit to transmit at least part of the resource configuration which is updated to the at least one vehicle mounted device.

### BRIEF DESCRIPTION OF THE DRAWINGS

FIG. 1 illustrates a resource configuration of an internet of vehicles.

FIG. 2A shows the internet of vehicles according to an embodiment.

FIG. 2B shows an internet of vehicles according to another embodiment.

FIG. 3A shows a flowchart of a dynamic resource managing method of the internet of vehicles according to one embodiment.

FIG. 3B shows a flowchart of dynamic resource managing method of the internet of vehicles according to one embodiment.

FIG. 3C shows a flowchart of dynamic resource managing method of the internet of vehicles according to another embodiment.

FIG. 4 illustrates the step S120 according to one embodiment.

FIGS. 5A to 5B illustrate the step S120 according to another embodiment

FIGS. 6 to 8 illustrate several examples of changing the resource configuration.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

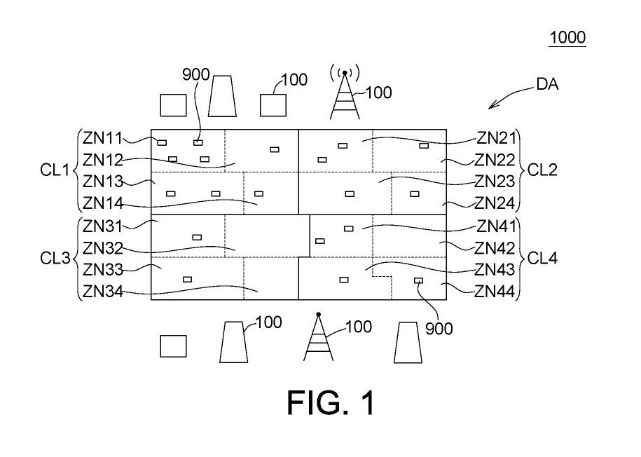

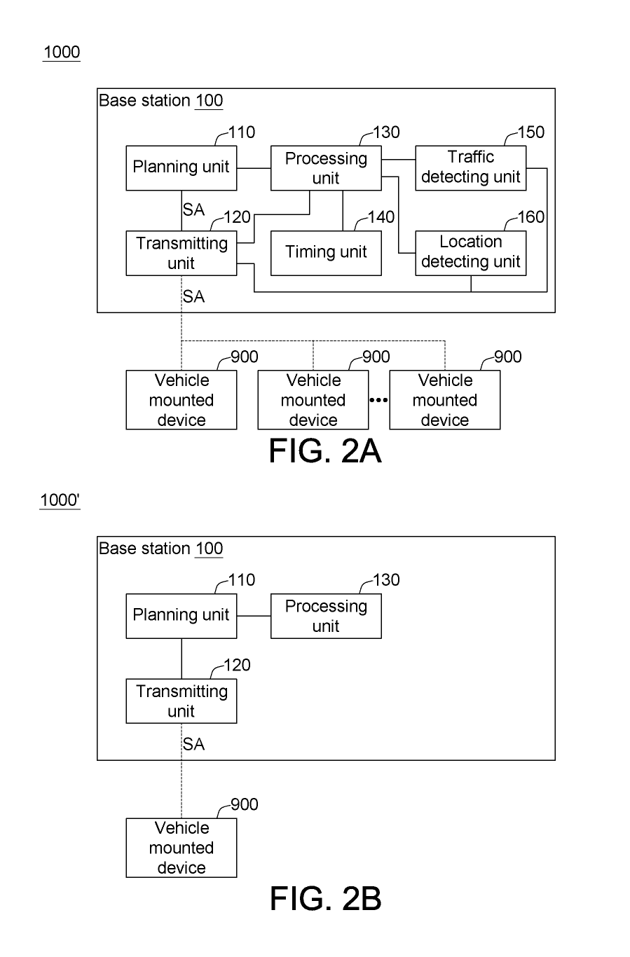

Please refer to FIG. 1, which illustrates a resource configuration SA (labeled in FIG. 2A) of an internet of vehicles 1000. In one embodiment, the internet of vehicles 1000 includes Vehicle to Vehicle (V2V) and/or Vehicle to Everything (V2X). In the resource configuration SA, a deploying area DA is divided into a plurality of clusters (shown as the solid line). Each of the clusters is divided into a plurality of zones (shown as the dotted line). In one embodiment, the deploying area DA may be a section of a road. For example, the deploying area DA of FIG. 1 is divided into 4 clusters CL1, CL2, CL3, CL4. The cluster CL1 includes 4 zones ZN11, ZN12, ZN13, ZN14. The cluster CL2 includes 4 zones ZN21, ZN22, ZN23, ZN24. The cluster CL3 includes 4 zones ZN31, ZN32, ZN33, ZN34. The cluster CL4 includes 4 zones ZN41, ZN42, ZN43, ZN44. The sizes of the clusters CL1 to CL14 may be different. The sizes of the zones ZN11 to ZN44 may be different. The shape of each of the clusters CL1 to CL4 may be a rectangle or a polygon. The shape of zones ZN11 to ZN44 may be a rectangle or a polygon. In each of the clusters CL1 to CL4, the arrangement and/or the number of the zones ZN11 to ZN44 may be identical, similar or different. The resource pools, such as the bandwidths or the transmission paths, assigned to some of the zones ZN11 to ZN44 which are adjacent may be different. The resource pools assigned to different zones in the different clusters CL1 to CL4 may be identical. The resource pools assigned to the zones ZN11 to ZN14 in the cluster CL11 may be different. In one embodiment, as shown in FIG. 1, the resource pools assigned to the cluster CL1, the cluster CL2, the cluster CL3 and the cluster CL4 may be identical. For example, the resource pools include a first resource pool, a second resource pool, a third resource pool and a fourth resource pool. The first resource pool, the second resource pool, the third resource pool and the fourth resource pool are respectively assigned to the zone ZN11, the zone ZN12, the zone ZN13 and the zone ZN14 in the cluster CL1. Similarly, the first resource pool, the second resource pool, the third resource pool and the fourth resource pool are respectively assigned to the zone ZN21, the zone ZN22, the zone ZN23 and the zone ZN24 in the cluster CL2. The resource pools assigned to the cluster CL3 and the cluster CL4 may be similar as above. The first resource pool is assigned to the zone ZN11 in the cluster CL1 and the zone ZN12 in the cluster CL2. According to the resource configuration SA, the resource pools provided from the base station 100 to the vehicle mounted devices 900 will not be conflicted with each other. The base station 100 may be a radio station or a road side unit (RSU). The vehicle mounted devices 900 may be electronic devices or electronic tags fixedly disposed on movable vehicles, such as cars, motorcycles, bicycles, ships or airplanes. The vehicle mounted devices 900 may also be portable devices, such as cell phones, notebook computers or smart watches.

In the present embodiment, the resource configuration SA can be dynamically updated to optimize the use of the resource pools. Please refer to FIG. 2A, which shows the internet of vehicles 1000 according to an embodiment. The internet of vehicles 1000 includes at least one base station 100 and at least one vehicle mounted device 900. The base station 100 can plan the resource configuration SA. The vehicle mounted devices 900 use the resource pools according to the resource configuration SA. In FIG. 2A, only one base station 100 is shown. However, in another embodiment, the number of at least one the base station 100 is plurality, and many-to-many transmission is formed between the base stations 100 and the vehicle mounted devices 900.

The base station 100 includes a planning unit 110, a transmitting unit 120, a processing unit 130, a timing unit 140, a traffic detecting unit 150 and a location detecting unit 160. The planning unit 110 is used for performing various planning procedures. The transmitting unit 120 is used for performing a data transmitting procedure and a data receiving procedure. The processing unit 130 is used for performing various processing procedures, various calculating procedures, various determining procedures and various controlling procedures. The timing unit 140 is used for counting time. The traffic detecting unit 150 is used for detecting the traffic status. The location detecting unit 160 is used for detecting the location distribution of the vehicle mounted devices 900. Each of the planning unit 110, the processing unit 130, the traffic detecting unit 150 and the location detecting unit 160 may be a chip, a circuit, a circuit board or a storage device storing a plurality of program codes. The timing unit 140 may be a timing chip, a network receiver for receiving the network time, a quartz clock or a circuit/software/firmware comprising an oscillator. The transmitting unit 120 may be a wireless transmitting module (wireless transmitting circuit, wireless transmitting chip or wireless transmitting device) composed of antenna, radio frequency chip and/or baseband circuit. In one embodiment, the base station 100 may include a processor, and the planning unit 110, the transmitting unit 120, the processing unit 130, the timing unit 140, the traffic detecting unit 150 and/or the location detecting unit 160 can be program codes which are executed by the processor to realize those functions.

Please refer to FIG. 2B, which shows an internet of vehicles 1000′ according to another embodiment. In one embodiment, the base station 100 may include the planning unit 110, the transmitting unit 120 and the processing unit 130 only, and the number of the vehicle mounted device 900 may be one (or plurality). In this embodiment, the dynamic resource managing method can be implemented in the internet of vehicles 1000′.

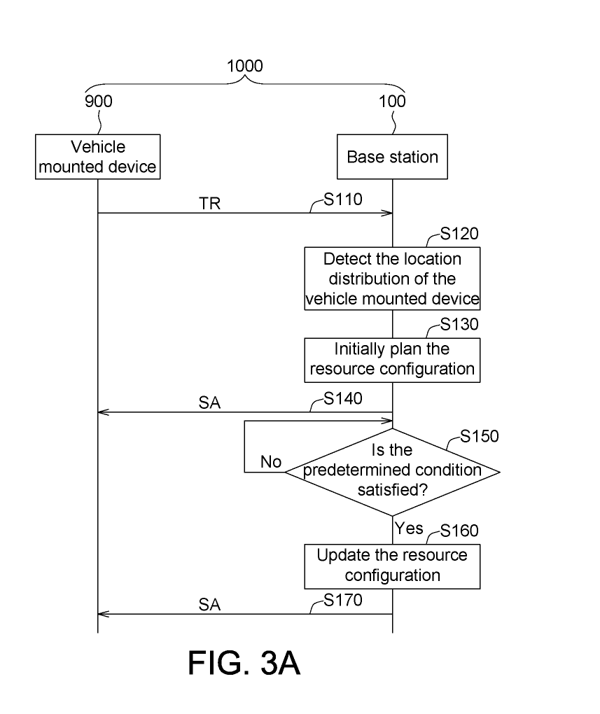

Please refer to FIGS. 3A to 3C. The FIG. 3A shows a flowchart of a dynamic resource managing method of the internet of vehicles 1000 according to one embodiment. The FIG. 3B shows a flowchart of dynamic resource managing method of the internet of vehicles 1000′ according to one embodiment. The FIG. 3C shows a flowchart of dynamic resource managing method of the internet of vehicles 1000′ according to another embodiment. The dynamic resource managing method is, but not limited to, illustrated by the internet of vehicles 1000 and the base station 100 of the FIG. 2A.

In the step S110, at least one of the vehicle mounted devices 900 transmits a transmission request TR to the base station 100. The base station 100 receives the transmission request TR by the transmitting unit 120.

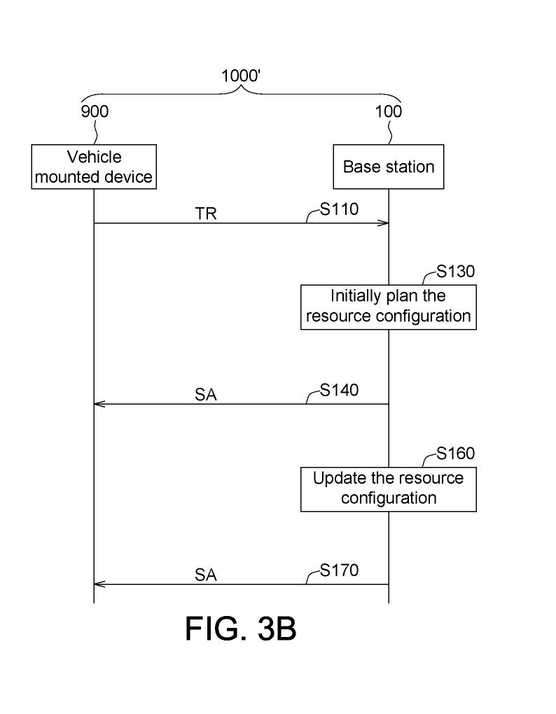

Next, in the step S120, the location detecting unit 160 of the base station 100 detects the location distribution of the vehicle mounted devices 900. In this step, the base station 100 may obtain the location distribution of the vehicle mounted devices 900 via the global positioning system (GPS) information. Please refer to FIG. 4, which illustrates the step S120 according to one embodiment. Each of the vehicle mounted devices 900 can obtain a geographic information GI by a GPS receiver. Then, each of the vehicle mounted devices 900 transmits its geographic information GI to the base station 100. The base station 100 obtains the location distribution of the vehicle mounted devices 900 according to the geographic information GI.

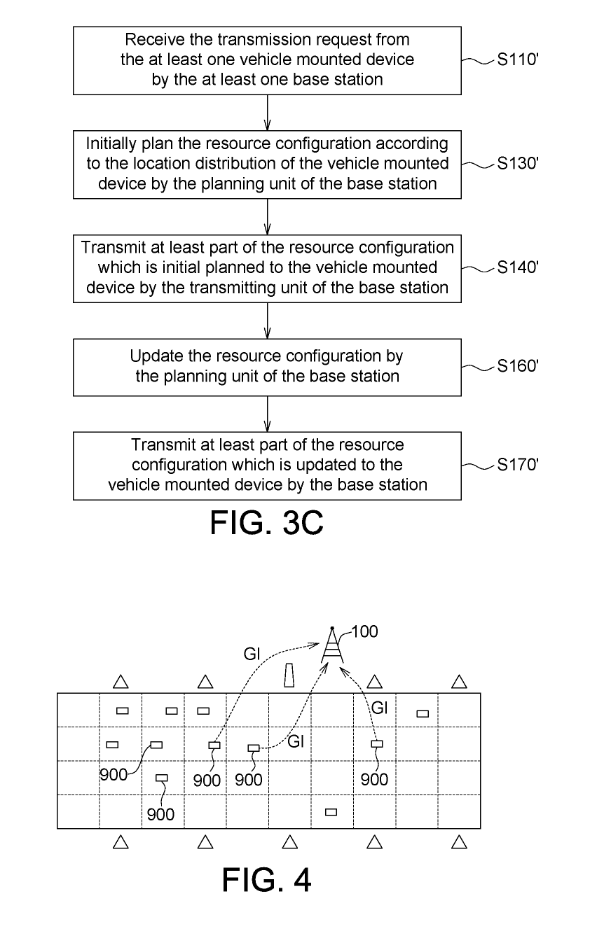

The base station 100 can obtain the location distribution of the vehicle mounted devices 900 by a grid analysis algorithm (for example, if the GPS receiver cannot be used to receive the geographic information GI). Please refer to FIGS. 5A to 5B, which illustrate the step S120 according to another embodiment. In another embodiment, the location detecting unit 160 divides the zone ZN into a plurality of partitions GD. Then, the vehicle mounted device 900 broadcasts a reference signal RS to several base stations 100. The signal strength of the reference signal RS received by the base station 100 which is near the vehicle mounted device 900 is high; the signal strength of the reference signal RS received by the base station 100 which is far from the vehicle mounted device 900 is low. After the base stations 100 receive the reference signal RS, the signal strength SS of the reference signal RS can be transmitted to and collected at one of the base stations 100. This base station 100 can know that the vehicle mounted device 900 is located at one particular partition GD according to the signal strengths SS. An identification code of the vehicle mounted device 900 can be attached on the reference signal RS. If there are several vehicle mounted devices 900, this base station 100 can know the location of each of the vehicle mounted devices 900 according to the reference signals RS and the identification code attached thereto. As shown in FIG. 5B, whether each of the partition GD is occupied by one of the vehicle mounted devices 900 is determined. For example, “1” means that there is one vehicle mounted device 900 located at this partition GD, “0” means that there is no vehicle mounted device 900 located at this partition GD. As such, the location distribution of the vehicle mounted device 900 can be obtained. In one embodiment, the transmission delay of the reference signal RS received by the base station 100 which is near the vehicle mounted device 900 is small; the transmission delay of the reference signal RS received by the base station 100 which is far from the vehicle mounted device 900 is large. After the base stations 100 receive the reference signal RS, the transmission delay of the reference signal RS can be transmitted to and collected at one of the base stations 100. This base station 100 can know that the vehicle mounted device 900 is located at one particular partition GD according to the transmission delay. As such, the location distribution of the vehicle mounted devices 900 can be obtained. In another embodiment, the location distribution of the vehicle mounted devices 900 can be obtained according to the signal strength SS and/or the transmission delay. In one embodiment, after the base station 100 receives the geographic information GI of each of the vehicle mounted devices 900, the location of the vehicle mounted devices 900 can be recorded in the partition GD accordingly and the location distribution of the vehicle mounted devices 900 can be obtained.

The size of the partition GD may be an occupied range of one vehicle mounted device 900. Also, the size of the partition GD can be set according to a predetermined interval among the vehicle mounted devices 900. For example, the size of the partition GD can be set according to the length of the vehicle, the width of the road and the limit of driving speed.

Next, in the step S130, the planning unit 110 initially plans the resource configuration SA. The planning unit 110 may initially plan the size of each of the zones ZN and the resource pools assigned to the zones ZN according to the location distribution of the vehicle mounted device 900. For example, for a crowded section of a road, the planning unit 110 narrows each of the zones ZN, to avoid too many vehicle mounted devices 900 being located in the same zone ZN and to avoid the resource pools being too contended. On the other hand, for a sparse section, the planning unit 110 enlarges each of the zones ZN, to avoid the resource pools being wasted.

In another embodiment, the step S120 may be omitted, and the resource configuration SA is initially planned according to the predetermined settings or the previous records.

Then, in the step S140, the transmitting unit 120 of the base station 100 transmits the resource configuration SA which is initially planned to the vehicle mounted devices 900, such that the vehicle mounted devices 900 use the resource pools according to the resource configuration SA which is initially planned.

In this step, the transmitting unit 120 of the base station 100 can transmit the resource configuration SA which is initially planned via the system information block (SIB).

In one embodiment of the step S130, the planning unit 110 of the base station 100 may initially plan the resource configuration SA of the deploying area DA, the resource configuration SA of the clusters CL, the resource configuration SA of the zones ZN, and/or the resource configuration SA of the vehicle mounted device 900. In one embodiment of the step S140, the transmitting unit 120 of the base station 100 may transmit whole of the resource configuration SA to the vehicle mounted device 900. The transmitting unit 120 of the base station 100 may transmit the resource configuration SA of the deploying area DA (for example, the arrangement of the clusters CL and the zones ZN in this deploying area DA and/or the resource pools configured for the clusters CL and the zones ZN in this deploying area DA) where the vehicle mounted device 900 is located to this vehicle mounted device 900. The transmitting unit 120 of the base station 100 may transmit the resource configuration SA of the cluster CL (for example, the arrangement of the zones ZN in this cluster CL and/or the resource pools configured for the zones ZN in this cluster CL) where the vehicle mounted device 900 is located to this vehicle mounted device 900. The transmitting unit 120 of the base station 100 may transmit the resource configuration SA of the zone ZN (for example, the resource pools configured for the zone ZN where the vehicle mounted device 900) where the vehicle mounted device 900 is located to this vehicle mounted device 900. The transmitting unit 120 of the base station 100 may transmit the resource configuration SA of the vehicle mounted device 900 (for example, the resource pools configured for the vehicle mounted device 900) to this vehicle mounted device 900.

Next, in the step S150, the processing unit 130 of the base station 100 determines whether a predetermined condition is satisfied. In one embodiment, the timing unit 140 counts an accumulated time. If the processing unit 130 determines that the accumulated time reaches a predetermined time, then it is determined that the predetermined condition is satisfied. The predetermined time is a presetting value. In one embodiment, the predetermined time can be adjusted according to the traffic status.

Or, in another embodiment, the traffic detecting unit 150 may detect the driving speed of the vehicle mounted devices 900. If the processing unit 130 determines that a change of the driving speed of the vehicle mounted device 900 is larger than a threshold, then it is determined that the predetermined condition is satisfied.

Or, in another embodiment, the location detecting unit 160 may detect the location distribution of the vehicle mounted devices 900. If the processing unit 130 determines that a change of the density of the vehicle mounted devices 900 is larger than a first threshold, then it is determined that the predetermined condition is satisfied. If the predetermined condition is satisfied, then the process proceeds to the step S160.

In another embodiment, the location detecting unit 160 may detects the location distribution of the base stations 100. Or, the location distribution of the base stations 100 is received from the transmitting unit 120 or a backend network. If the processing unit 130 determines that a change of the density of the base stations 100 is larger than a second threshold, then it is determined that the predetermined condition is satisfied. If the predetermined condition is satisfied, then the process proceeds to the step S160.

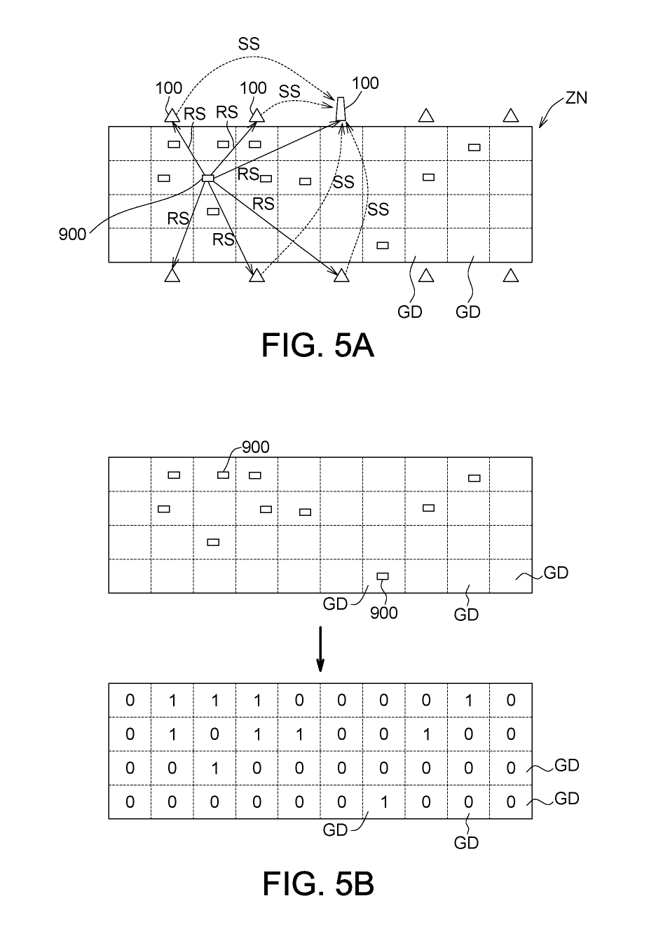

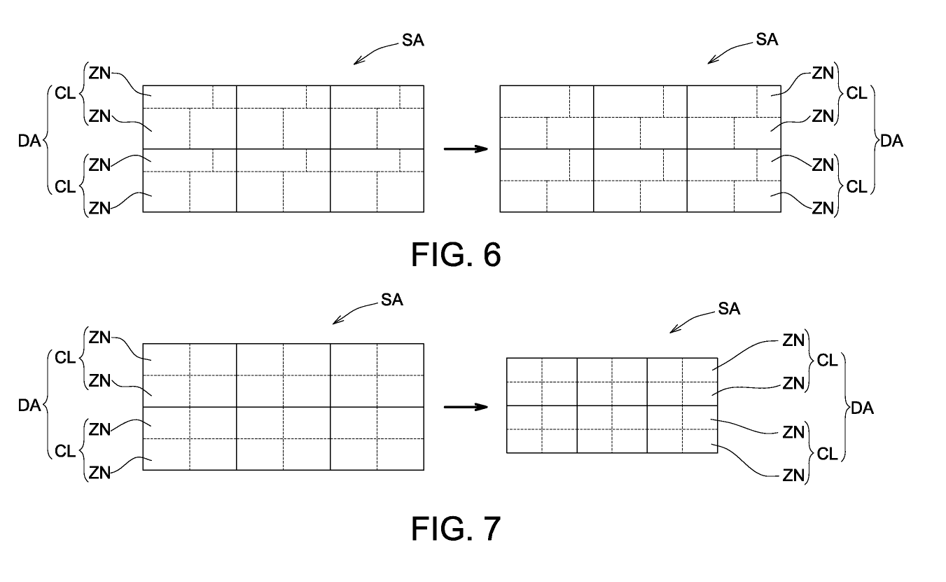

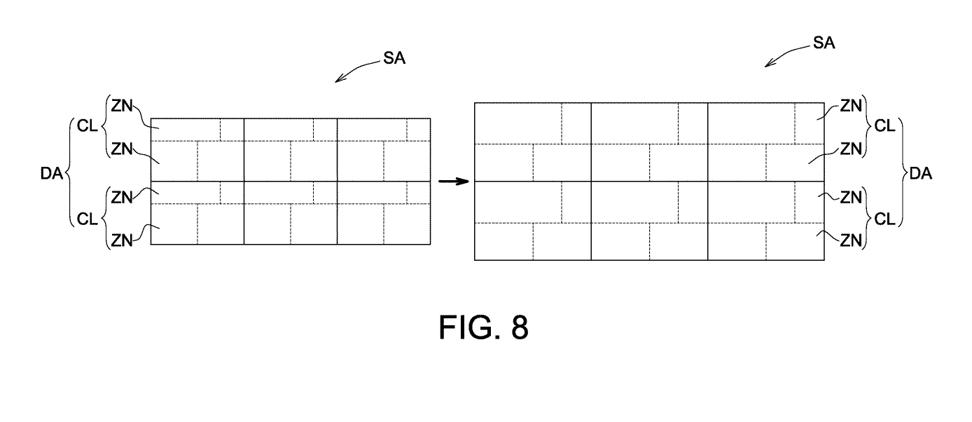

In the step S160, the planning unit 110 of the base station 100 updates the resource configuration SA. In this step, the planning unit 110 may update the ranges of the clusters CL, the ranges of the zones ZN and/or the resource configuration SA according to the location distribution of the vehicle mounted devices 900 and the number of the vehicle mounted devices 900 in each of the zones ZN. For example, please refer to FIGS. 6 to 8, which illustrate several examples of changing the resource configuration SA. As shown in FIG. 6, the planning unit 110 changes the range of each of the zones ZN in the resource configuration SA at left side to the resource configuration SA at right side. As shown in FIG. 7, the planning unit 110 changes the range of each of the clusters CL in the resource configuration SA. For example, if the width of the road is reduced from six-line to four-line, the ranges of the zones ZN, the ranges of the clusters CL and/or the range of the deploying area DA can be shrunk accordingly. Or, if the density of the vehicle mounted devices 900 becomes large, the ranges of the zones ZN, the ranges of the clusters CL and/or the range of the deploying area DA can be shrunk to reduce the number of the vehicle mounted device 900 in one of the zones ZN, in one of the clusters CL and/or in the deploying area DA, such that the conflict of the resource pools can be prevented. As shown in FIG. 8, the planning unit 110 changes the ranges of the clusters CL and the ranges of the zones ZN in the resource configuration SA. For example, if the width of the road is enlarged, the ranges of the zones ZN, the ranges of the clusters CL and/or the range of the deploying area DA are enlarged accordingly. Or, if the density of the vehicle mounted devices 900 becomes low, the ranges of the zones ZN, the ranges of the cluster CL and/or the range of the deploying area DA can be enlarged.

Or, in one embodiment, the planning unit 110 may change the relationship between the resource pools and the zones ZN.

Next, in the step S170, the transmitting unit 120 of the base station 100 transmits the resource configuration SA which is updated to the vehicle mounted devices 900, such that the vehicle mounted devices 900 use the resource pools according to the resource configuration SA which is updated. In this step, if the base station 100 is a radio station, then the base station 100 transmits the resource configuration SA which is updated via a Physical Uplink Control Channel (PUCCH). Or, if the base station 100 is a road side unit (RSU), then the base station 100 transmits the resource configuration SA which is updated via a partitioned and structured control channel (PSCCH).

In one embodiment of the step S170, when the transmitting unit 120 of the base station 100 transmits the resource configuration SA which is updated to the vehicle mounted device 900, the transmitting unit 120 of the base station 100 may transmit the resource configuration SA of the deploying area DA (for example, the arrangement of the clusters CL and the zones ZN in this deploying area DA and/or the resource pools configured for the clusters CL and the zones ZN in this deploying area DA) where the vehicle mounted device 900 is located to this vehicle mounted device 900. In one embodiment of the step S170, when the transmitting unit 120 of the base station 100 transmits the resource configuration SA which is updated to the vehicle mounted device 900, the transmitting unit 120 of the base station 100 may transmit the resource configuration SA of the cluster CL (for example, the arrangement of the zones ZN in this cluster CL and/or the resource pools configured for the zones ZN in this cluster CL) where the vehicle mounted device 900 is located to this vehicle mounted device 900. In one embodiment of the step S170, when the transmitting unit 120 of the base station 100 transmits the resource configuration SA which is updated to the vehicle mounted device 900, the transmitting unit 120 of the base station 100 may transmit the resource configuration SA of the zone ZN (for example, the resource pools configured for the zone ZN where the vehicle mounted device 900) where the vehicle mounted device 900 is located to this vehicle mounted device 900. In one embodiment of the step S170, when the transmitting unit 120 of the base station 100 transmits the resource configuration SA which is updated to the vehicle mounted device 900, the transmitting unit 120 of the base station 100 may transmit the resource configuration SA of the vehicle mounted device 900 (for example, the resource pools configured for the vehicle mounted device 900) to this vehicle mounted device 900.

Please refer to FIG. 3B, in the step S110, the at least one vehicle mounted device 900 transmits the transmission request TR to the base station 100. On the other hand, the at least one base station 100 receives the transmission request TR from the at least one vehicle mounted device 900. Then, in the step S130, the planning unit 110 of the base station 100 initially plans the resource configuration SA according to the location distribution of the vehicle mounted device 900. In the step S140, the transmitting unit 120 of the base station 100 transmits at least part of the resource configuration SA which is initially planned to the vehicle mounted device 900. In the step S160, the planning unit 110 of the base station 100 updates the resource configuration SA. Then, in the step S170, the base station 100 transmits at least part of the resource configuration SA which is updated to the vehicle mounted device 900. The detail illustration of the steps of the FIG. 3B is similar to that of the FIG. 3A.

Please refer to FIG. 3C, which shows a flowchart of the dynamic resource managing method of the base station 100 in the internet of vehicles 1000′. In the step S110′, the at least one base station 100 receives the transmission request TR from the at least one vehicle mounted device 900. Then, in the step S130′, the planning unit 110 of the base station 100 initially plans the resource configuration SA according to the location distribution of the vehicle mounted device 900. In the step S140′, the transmitting unit 120 of the base station 100 transmits at least part of the resource configuration SA which is initial planned to the vehicle mounted device 900. In the step S160′, the planning unit 110 of the base station 100 updates the resource configuration SA. Then, in the step S170′, the base station 100 transmits at least part of the resource configuration SA which is updated to the vehicle mounted device 900. The detail illustration of the steps of FIG. 3C is similar to that of FIGS. 3A to 3B.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A dynamic resource managing method of an internet of vehicles, comprising:
receiving a transmission request from at least one vehicle mounted device by at least one base station;
initially planning a resource configuration according to a location distribution of the at least one vehicle mounted device by the base station;
transmitting at least part of the resource configuration which is initially planned to the at least one vehicle mounted device from the base station;
updating the resource configuration by the base station; and
transmitting at least part of the resource configuration which is updated to the at least one vehicle mounted device from the base station.

2. The dynamic resource managing method of the internet of vehicles according to claim 1, wherein in the resource configuration, a deploying area is divided into a plurality of clusters, each of the clusters is divided into a plurality of zones, and in one of the clusters, a plurality of resource pools assigned to some of the zones which are adjacent are different.

3. The dynamic resource managing method of the internet of vehicles according to claim 2, wherein two resource pools assigned to two of the zones which respectively belong two of the clusters are identical.

4. The dynamic resource managing method of the internet of vehicles according to claim 2, wherein in the step of initially planning the resource configuration, the base station sets a size of each of the zones and a resource pool assigned thereto.

5. The dynamic resource managing method of the internet of vehicles according to claim 2, wherein in the step of updating the resource configuration, a plurality of ranges of the clusters, a plurality of ranges of the zones, or a plurality of resource pools assigned to the zones are updated.

6. The dynamic resource managing method of the internet of vehicles according to claim 5, wherein in the step of updating the resource configuration, the ranges of the zones are updated according to a number of the at least one vehicle mounted device.

7. The dynamic resource managing method of the internet of vehicles according to claim 2, further comprising:
detecting the location distribution of the at least one the vehicle mounted device by the base station.

8. The dynamic resource managing method of the internet of vehicles according to claim 7, the step of detecting the location distribution of the at least one the vehicle mounted device comprises:
dividing one of the zones to be a plurality of partitions by the base station; and
obtaining the location distribution of the at least one the vehicle mounted device on the partitions according to a signal strength or a transmission delay of a reference signal by the base station.

9. The dynamic resource managing method of the internet of vehicles according to claim 1, wherein if a predetermined time reaches, a change of a density of the at least one vehicle mounted device is larger than a first threshold or a change of a density of the at least one base station is larger than a second threshold, the step of updating the resource configuration is performed.

10. The dynamic resource managing method of the internet of vehicles according to claim 9, wherein the predetermined time is adjusted according to a traffic status.

11. The dynamic resource managing method of the internet of vehicles according to claim 1, wherein in the step of transmitting the at least part of the resource configuration which is initially planned, the base station transmits the at least part of the resource configuration which is initially planned via a system information block (SIB).

12. The dynamic resource managing method of the internet of vehicles according to claim 1, wherein the base station is a radio station, and in the step of transmitting the at least part of the resource configuration which is updated, the base station transmits the at least part of the resource configuration via a physical uplink control channel (PUCCH).

13. The dynamic resource managing method of the internet of vehicles according to claim 1, wherein the base station is a road side unit (RSU), and in the step of transmitting the at least part of the resource configuration which is updated, the base station transmits the at least part of the resource configuration via a partitioned and structured control channel (PSCCH).

14. An internet of vehicles, comprising:
at least one vehicle mounted device for transmitting a transmission request; and
at least one base station for receiving the transmission request, initially planning a resource configuration according to a location distribution of the at least one vehicle mounted, and transmitting at least part of the resource configuration which is initially planned to the at least one vehicle mounted device;
wherein the base station is further for updating the resource configuration and transmitting at least part of the resource configuration which is updated to the at least one vehicle mounted device.

15. The internet of vehicles according to claim 14, wherein in the resource configuration, a deploying area is divided into a plurality of clusters, each of the clusters is divided into a plurality of zones, and in one of the clusters, a plurality of resource pools assigned to some of the zones which are adjacent are different.

16. The internet of vehicles according to claim 15, wherein two resource pools assigned to two of the zones which respectively belong two of the clusters are identical.

17. The internet of vehicles according to claim 15, wherein when the base station initially plans the resource configuration, the base station sets a size of each of the zones and a resource pool assigned thereto.

18. The internet of vehicles according to claim 15, wherein when the base station updates the resource configuration, a plurality of ranges of the clusters, a plurality of ranges of the zones, or a plurality of resource pools assigned to the zones are updated.

19. The internet of vehicles according to claim 18, wherein the ranges of the zones are updated according to a number of the at least one vehicle mounted device.

20. The internet of vehicles according to claim 15, wherein the base station is further for detecting the location distribution of the at least one the vehicle mounted device.

21. The internet of vehicles according to claim 20, wherein the base station divides one of the zones to be a plurality of partitions, and obtains the location distribution of the at least one the vehicle mounted device on the partitions according to a signal strength or a transmission delay of a reference signal.

22. The internet of vehicles according to claim 14, wherein if a predetermined time reaches, a change of a density of the at least one vehicle mounted device is larger than a first threshold or a change of a density of the at least one base station is larger than a second threshold, the base station updates the resource configuration.

23. The internet of vehicles according to claim 22, wherein the predetermined time is adjusted according to a traffic status.

24. A base station, comprising:
a transmitting unit for receiving a transmission request from at least one vehicle mounted device;
a planning unit for initially planning a resource configuration according to a location distribution of the at least one vehicle mounted, wherein the transmitting unit is further for transmitting at least part of the resource configuration which is initially planned to the at least one vehicle mounted device; and
a processing unit for controlling the planning unit to update the resource configuration and controlling the transmitting unit to transmit at least part of the resource configuration which is updated to the at least one vehicle mounted device.

25. The base station according to claim 24, wherein in the resource configuration, a deploying area is divided into a plurality of clusters, each of the clusters is divided into a plurality of zones, and in one of the clusters, a plurality of resource pools assigned to some of the zones which are adjacent are different.

26. The base station according to claim 25, wherein two resource pools assigned to two of the zones which respectively belong two of the clusters are identical.

27. The base station according to claim 25, wherein when the planning unit initially plans the resource configuration, the planning unit sets a size of each of the zones and a resource pool assigned thereto.

28. The base station according to claim 25, wherein when the planning unit updates the resource configuration, a plurality of ranges of the clusters, a plurality of ranges of the zones, or a plurality of resource pools assigned to the zones are updated.

29. The base station according to claim 28, wherein the planning unit updates the ranges of the zones according to a number of the at least one vehicle mounted device.

30. The base station according to claim 24, further comprising:
a timing unit for counting an accumulated time; and
a location detecting unit for detecting a density of the at least one vehicle mounted device;
wherein if the accumulated time reaches a predetermined time or a change of the density of the at least one vehicle mounted device is larger than a threshold, the processing unit controls the planning unit to update the resource configuration.

31. The base station according to claim 30, further comprising:
a traffic detecting unit for detecting a traffic status, wherein the processing unit adjusts the predetermined time according to the traffic status.

32. The base station according to claim 24, wherein the transmitting unit transmits the at least part of the resource configuration which is initially planned via a system information block (SIB).

33. The base station according to claim 24, wherein the base station is a radio station, and the transmitting unit transmits the at least part of the resource configuration via a physical uplink control channel (PUCCH).

34. The base station according to claim 24, wherein the base station is a road side unit (RSU), and the transmitting unit transmits the at least part of the resource configuration via a partitioned and structured control channel (PSCCH).

35. The base station according to claim 24, further comprising:
a location detecting unit for dividing one of the ones to be a plurality of partitions, and obtaining the location distribution of the at least one the vehicle mounted device on the partitions according to a signal strength or a transmission delay of a reference signal.
